(19) United States
(12) Patent Application Publication
(10) Pub. No.: US 2018/0174237 A1
(43) Pub. Date: Jun. 21, 2018

(54) METHOD AND SYSTEM FOR PERSON-TO-PERSON ARBITRARY CURRENCY EXCHANGE SERVICE

(71) Applicant: Mastercard International Incorporated, Purchase, NY (US)

(72) Inventors: Ahmed HOSNY, Dublin 18 (IE); Peter J. GROARKE, Dublin 18 (IE)

(73) Assignee: Mastercard International Incorporated, Purchase, NY (US)

(21) Appl. No.: 15/386,683

(22) Filed: Dec. 21, 2016

(51) Int. Cl. G06Q 40/04; G06F 17/30; G06Q 20/10

(52) U.S. Cl. CPC G06Q 40/04; G06Q 20/102; G06F 17/30867

(57) ABSTRACT

A method for arbitrary exchange of currency includes: storing account profiles, each including account details and a currency type; receiving a currency exchange request including a first currency amount of a first currency type to be exchanged for a second currency amount of a second currency type and delivery information; identifying a first account profile that includes the first currency type and a second account profile that includes the second currency type; identifying a first controlled payment number mapped to the transaction account related to the first account profile and limited to the first currency amount, and a second controlled payment number mapped to the transaction account related to the second account profile and limited to the second currency amount; and transmitting the second controlled payment number in response to the received currency exchange request, and the first controlled payment number based on the received delivery information.

### FIELD

The present disclosure relates to arbitrary exchanges of currency, specifically the use of controlled payment numbers to enable two entities to exchange currencies at an arbitrary rate agreed to by both parties that is not affected by market exchange rates or other outside considerations.

### BACKGROUND

There are any number of circumstances where an individual or other entity (e.g., a business) may need to engage in commerce using a currency different from their usual one. For instance, an individual may go on vacation in a foreign country that uses a different currency, or a business may purchase products from another business located in a different country that uses a different currency. Traditionally, entities may use a transaction account associated with their home currency for such transactions. In these cases, the transaction, commonly referred to as a cross-border transaction, will incorporate a currency exchange. However, exchange rates used during the processing of a transaction are often less favorable to entities than market exchange rates.

As such, many entities may often have a desire to exchange their home currency for a foreign currency prior to transacting. In such cases, entities are at the mercy of currency exchange service providers with respect to the rate that is charged for the conversion. In many instances, these service providers may utilize exchange rates that are considerably less favorable than market rates, taking advantage of the entity's position (e.g., due to lack of alternative providers, ability for the provider to exchange using a payment card, convenience, etc.). In these cases, the entity may have very little control over the rate at which their currency is exchanged. The same may also be true for a second entity that has a desire to exchange their currency to the same currency used by the first entity. In such instances, two entities may be willing to exchange currency to one another at an agreed-upon rate. However, unless the two both have a sufficient amount of physical currency, there are no systems developed to enable the two entities to exchange currency at their agreed-upon rate.

Thus, there is a need for a technological solution to enable two entities to exchange currency at an arbitrary rate selected by the entities, which can be done using transaction accounts without requiring the exchange of physical currency.

### SUMMARY

The present disclosure provides a description of systems and methods for the arbitrary exchange of currency. The present systems and methods utilize controlled payment numbers associated with transaction accounts in each of the currencies to distribute currency to two entities using an exchange rate that is agreed upon by both entities. The controlled payment numbers are distributed to each of the two entities and are issued for the amount that is being exchanged via the agreement, such that each of the two entities receive a controlled payment number suitable for use in any electronic transaction utilizing that currency, and in the amount that was agreed upon. As a result, two entities can exchange currency at any rate they wish, without having to perform any physical exchange, or without involving either entity in a cross-border transaction, which may save each entity time, resources, and expenses in procuring a desired amount of foreign currency.

A method for arbitrary exchange of currency includes: storing, in an account database of a processing server, a plurality of account profiles, wherein each account profile includes data related to a transaction account including at least account details and a currency type; receiving, by a receiving device of the processing server, a currency exchange request, wherein the currency exchange request includes at least a first currency amount of a first currency type to be exchanged for a second currency amount of a second currency type and delivery information; executing, by a querying module of the processing server, one or more queries on the account database to identify a first account profile that includes a currency type corresponding to the first currency type and a second account profile that includes a currency type corresponding to the second currency type; identifying, by a data identification module of the processing server, a first controlled payment number and a second controlled payment number, wherein the first controlled payment number is mapped to the transaction account related to the first account profile and is limited to the first currency amount, and wherein the second controlled payment number is mapped to the transaction account related to the second account profile and is limited to the second currency amount; and electronically transmitting, by a transmitting device of the processing server, the second controlled payment number in response to the received currency exchange request, and the first controlled payment number based on the received delivery information.

A system for arbitrary exchange of currency includes: an account database of a processing server configured to store a plurality of account profiles, wherein each account profile includes data related to a transaction account including at least account details and a currency type; a receiving device of the processing server configured to receive a currency exchange request, wherein the currency exchange request includes at least a first currency amount of a first currency type to be exchanged for a second currency amount of a second currency type and delivery information; a querying module of the processing server configured to execute one or more queries on the account database to identify a first account profile that includes a currency type corresponding to the first currency type and a second account profile that includes a currency type corresponding to the second currency type; a data identification module of the processing server configured to identify a first controlled payment number and a second controlled payment number, wherein the first controlled payment number is mapped to the transaction account related to the first account profile and is limited to the first currency amount, and wherein the second controlled payment number is mapped to the transaction account related to the second account profile and is limited to the second currency amount; and a transmitting device of the processing server configured to electronically transmit the second controlled payment number in response to the received currency exchange request, and the first controlled payment number based on the received delivery information.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for facilitating an arbitrary exchange of currency using controlled payment numbers in accordance with exemplary embodiments.

FIG. 2 is a block diagram illustrating the processing server of the system of FIG. 1 for facilitating an arbitrary exchange of currency in accordance with exemplary embodiments.

FIG. 3 is a flow diagram illustrating a process for an arbitrary exchange of currency using controlled payment numbers in the system of FIG. 1 in accordance with exemplary embodiments.

FIG. 4 is a flow chart illustrating an exemplary method for arbitrary exchange of currency in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

Controlled Payment Number—Controlled payment numbers may be payment numbers associated with a payment account that are subject to one or more rules. In many cases, these rules may be set by a cardholder, such as spending limits, limits on days and/or times of a transaction, limits on merchants or industries, transaction spending or frequency limits, etc. Controlled payment numbers may offer an account holder an opportunity to give payment cards tied to the account to others for use, but subject to rules set by the cardholder, such as an employer distributing cards to employees, or a parent distributing cards to children. Additional detail regarding controlled payment numbers may be found in U.S. Pat. No. 6,636,833, issued Oct. 21, 2003; U.S. Pat. No. 7,136,835, issued Nov. 14, 2006; U.S. Pat. No. 7,571,142, issued Aug. 4, 2009; U.S. Pat. No. 7,567,934, issued Jul. 28, 2009; U.S. Pat. No. 7,593,896, issued Sep. 22, 2009; U.S. patent application Ser. No. 12/219,952, filed Jul. 30, 2008; U.S. patent application Ser. No. 12/268,063, filed Nov. 10, 2008; and U.S. patent application Ser. No. 12/359,971, filed Jan. 26, 2009; each of which are herein incorporated by reference in their entirety.

### System for Arbitrary Exchange of Currency

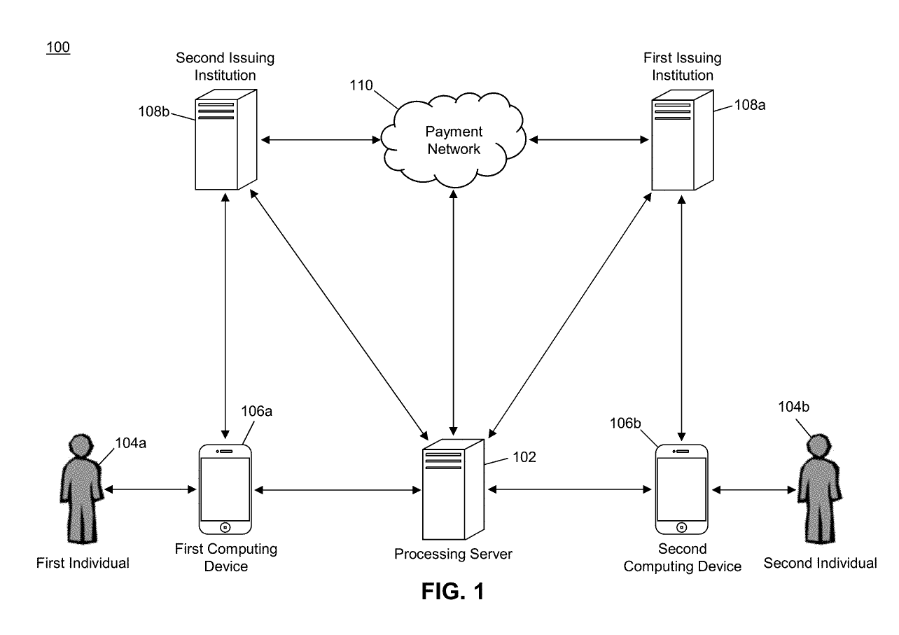

FIG. 1 illustrates a system 100 for the arbitrary exchange of currency between two entities at an agreed-upon rate via the use of controlled payment numbers.

The system 100 may include a processing server 102. The processing server 102, discussed in more detail below, may be configured to facilitate the exchange of currency between two entities 104, such as a first individual 104a and a second individual 104b, at a rate agreed upon by both of the entities 104, via the use of transaction accounts and controlled payment numbers, without the use of physical currency and unaffected by market or other outside exchange rates. The processing server 102, as discussed below, may be a specialized computing system that is specifically configured to perform the functions discussed herein.

In the system 100, each individual 104 that desires a currency exchange may possess a computing device 106. As illustrated in FIG. 1, the first individual 104a may possess a first computing device 106a, and the second individual 104b may possess a second computing device 106b. Each computing device 106 may be any type of computing device suitable for performing the functions discussed herein, like a specifically configured cellular phone, smart phone, smart watch, wearable computing device, implantable computing device, desktop computer, laptop computer, notebook computer, tablet computer, smart television. Using the computing device 106, the first individual 104a may submit a request to the processing server 102 to exchange currency at a specified rate with the second individual 104b. The request may be submitted to the processing server 102 via any suitable communication network via any suitable method, such as via a web page, application programming interface, application program associated with the processing server 102, etc. For instance, the first computing device 106a may execute an application program associated with the processing server 102 that provides a user interface for input of details related to the request.

The request may be submitted to the processing server 102 to request an arbitrary exchange of currency. The request may include at least one amount of a first currency being exchanged and may further include an amount of the second currency being exchanged and/or a rate of exchange for the first currency to the second currency. For instance, the first individual 104a may specify that they want to exchange $100 to £85, may specify that they want to exchange $100 at a rate of £0.85 per USD, or may specify that they want to exchange $100 at a rate of £0.85 per USD and receive £85.

In some embodiments, the first individual 104a may specify the second individual 104b with whom the currency is to be exchanged. In such embodiments, the first individual 104a may provide contact information associated with the second individual 104b, for use by the processing server 102 contacting the second individual 104b for confirmation of the currency exchange. For instance, the first individual 104a may supply a device identifier associated with the second computing device 106b, such as a telephone number, media access control address, etc., or other suitable identifier used to contact the second individual 104b, such as a username or e-mail address used in registration with the application program associated with the processing server 102. The processing server 102 may then forward the details of the request to the second computing device 106b for confirmation by the second individual 104b of the currency amounts being exchanged and the arbitrary rate.

In other embodiments, the processing server 102 may be configured to identify a suitable second individual 104b that is willing to exchange the second currency for the first currency at the rate submitted to by the first individual 104a. For instance, the first individual 104a may submit a request with the desire to exchange $100 for £85, while the second individual 104b may submit a request to the processing server 102 with the desire to exchange £85 for $100. The processing server 102 may match the individuals accordingly to facilitate the exchange. In some such embodiments, the processing server 102 may be configured to communicate with each of the individuals 104 via their associated computing devices 106 if the requests match at least two of the criteria for exchange (e.g., first and second currency types, first currency amount, second currency amount) to determine if either individual 104 is willing to compromise to accomplish the exchange. For example, the first individual 104a may submit a request to exchange $110 for £93, and the second individual 104b may submit a request to exchange £80 for $94. As both individuals 104 want to exchange the same types of currency at nearly the same rate and for similar amounts, the processing server 102 may communicate with each individual 104 (e.g., via their associated computing devices 106) and suggest an exchange of $100 for £85 between the two.

In addition to selecting terms for the currency exchange, each of the individuals 104 may submit payment details for payment of the currency that they are offering for exchange. The payment details may be submitted as part of the request, or may be submitted to the processing server 102 once the details of the request have been confirmed by both individuals 104. The payment details may be details associated with a transaction account issued to the respective individual that are used in an electronic payment transaction for funding of that electronic payment transaction by the associated transaction account. Payment details may include, for instance, a transaction account number, expiration date, security code, name, and billing address.

Once the exchange details have been confirmed and payment details received, the processing server 102 may identify a transaction account for both of the currencies being exchanged that is to be used to facilitate the exchange. The processing server 102 may identify a first transaction account that is associated with the first currency, which may be issued by or otherwise associated with a first issuing institution 108a. For instance, in the above example, the first issuing institution 108a may have a transaction account associated therewith that deals in USD. The processing server 102 may also identify a second transaction account that is associated with the second currency. In some cases, the second transaction account may also be associated with the first issuing institution 108a, or may be associated with a second issuing institution 108b. In the above example, the second transaction account may deal in GBP.

The processing server 102 may initiate payment from each of the individuals 104 to the corresponding issuing institution 108 for the amount in the respective currency. For instance, in the above example, the processing server 102 may initiate an electronic payment transaction from the first individual 104a (e.g., from the transaction account associated with the payment details submitted by the first individual 104a) to the first issuing institution 108a (e.g., to the transaction account associated therewith that deals in USD) for payment of $100 from the first individual 104a to the first issuing institution 108a. The processing server 102 may also initiate an electronic payment transaction for payment of £85 from the second individual 104b to the second issuing institution 108b.

In some embodiments, the processing server 102 may submit each payment transaction directly to a payment network 110 for processing. For instance, the processing server 102 may generate a transaction message for each payment transaction and electronically transmit the transaction message to the payment network 110 via payment rails associated therewith, where the transaction message may be a specially formatted data message formatted pursuant to one or more standards governing the exchange of financial transaction messages, such as the International Organization of Standardization's ISO 8583 or ISO 20022 standards. The transaction message for the payment transaction involving the first individual 104a may thus include, for example, USD as the currency type, payment details of the transaction account associated with the first individual 104a, details of the first issuing institution 108 as recipient of the payment, and the $100 as the transaction amount. In some instances, the processing server 102 may electronically transmit the transaction information to an acquiring financial institution or other entity for submission to the payment network 110 on behalf of the processing server 102. In other embodiments, the processing server 102 may utilize a third party transaction processor for processing of each of the transactions involved in the arbitrary currency exchange.

If each of the transactions are approved and successfully processed, the processing server 102 may identify a controlled payment number (CPN) for each of the transaction accounts associated with the issuing institution(s) 108. A first CPN may be identified associated with the transaction account that deals in the first currency, where the CPN may be subject to at least one transaction control limiting usage of the CPN to a total spending amount equal to the amount of the first currency. In the above example, the CPN will be subject to a transaction control limiting spending to $100. The CPN may be mapped to the transaction account associated with the first issuing institution 108a that deals in USD, such that when the CPN is used to fund an electronic payment transaction, the mapped transaction account is the one used to actually fund the transaction. The transaction control may be such that the CPN may only be used to fund $100 of electronic payment transactions, after which any transaction in which the CPN is used will be denied due to non-compliance with the transaction control. In some cases, additional transaction controls may be set for a CPN. For instance, the CPN may be limited for usage in only payment transactions conducted using the assigned currency (e.g., preventing usage in cross-border transactions), or may be limited for usage for a predetermined period of time after distribution (e.g., the CPN must be used within three weeks of receipt).

In some embodiments, the CPN may be generated or otherwise identified directly by the processing server 102. For instance, the processing server 102 may be configured to generate CPNs on transaction accounts and establish transaction controls therefor, and may generate the CPN for the first transaction account. In other embodiments, the processing server 102 may use an application programming interface or other suitable method to submit a request for a CPN to the first issuing institution 108a or other suitable entity for the generation of a CPN that is limited to the first currency amount as indicated in the exchange request (e.g., $100), and may receive the CPN as a result. As used herein, the “controlled payment number” or “CPN” may refer to the actual number to be submitted in electronic payment transactions using the CPN as well as any other details necessary for use in electronic payment transactions, such as an expiration date, name, security code, etc. In some cases, the name associated with an identified CPN may be the name of the individual 104 to receive the CPN as part of the methods discussed herein.

Once a CPN has been identified, it may be distributed to the corresponding individual 104. For instance, the CPN that is issued on the first transaction account (e.g., associated with the first issuing institution 108a) for $100 may be distributed to the second individual 104b, and the CPN that is issued on the second transaction account (e.g., associated with the second issuing institution 108b) for £85 may be distributed to the first individual 104a. In some instances, the processing server 102 may distribute the CPN to the respective individual 104. In other instances, the issuing institution 108 may distribute the CPN directly to the respective individual 104, where the issuing institution 108 may be provided contact information of the individual 104 by the processing server 102 or other entity as part of the request submitted for identification of the CPN.

In some embodiments, the CPN may be distributed to the computing device 106 associated with the respective individual 104. For instance, the CPN may be provisioned to the computing device 106 using any suitable method for the provisioning of payment credentials to a computing device 106 for use in electronic payment transactions, such as the provisioning of payment credentials to an electronic wallet application program, or inclusion of the CPN details in an e-mail message or text message electronically transmitted to the computing device 106. In some cases, an individual 104 may be able to request a physical payment card be issued for use of the CPN, where the physical payment card may be encoded with the CPN details, such as in a magnetic strip or an integrated circuit. Once the individual 104 has received the CPN details, the individual 104 may then use the CPN in an electronic payment transaction to avail themselves of the foreign currency.

The methods and systems discussed herein can thus enable two individuals 104 to exchange currency with one another at an arbitrary exchange rate where the exchange may be funded via transaction accounts associated with the respective individual 104, and where each individual 104 may receive a CPN that is limited to the amount received as part of the exchange. The use of CPNs may ensure that each individual 104 has access to only the exchanged amount of currency, without requiring each individual 104 to have an account that deals in that type of currency, and without having to have multiple transaction accounts for each type of currency. In other words, every currency exchange involving one type of currency may utilize CPNs issued on a single transaction account, enabling the methods and systems discussed herein to be implemented using a single transaction account for each of the currencies involved, limiting the number of involved transaction accounts to the number of currencies that may be exchanged. In addition, the methods and systems discussed herein provide for exchanges of currency that do not involve any cross-border transactions, which may reduce the fees incurred in the transactions discussed herein, thereby reducing expenses, and also provide for all currency exchanges to be performed without the use of any direct conversions of currency, reducing the potential of loss of issuing institutions 108 that may be suffered in currency exchanges.

### Processing Server

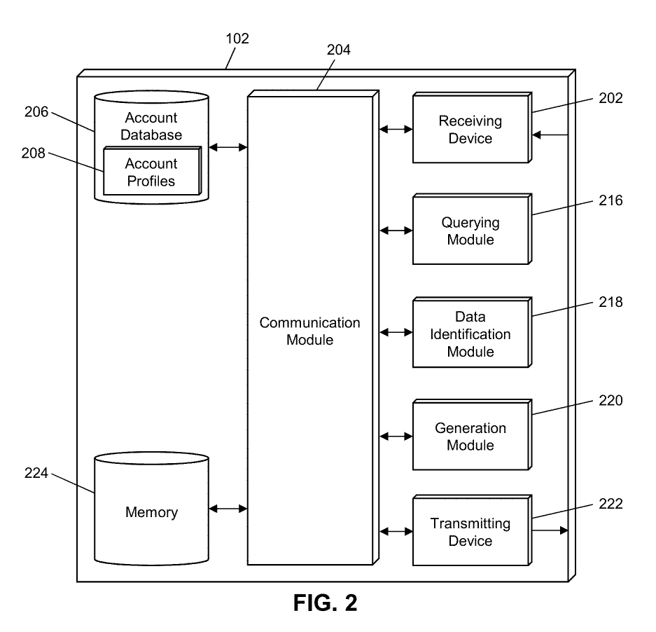

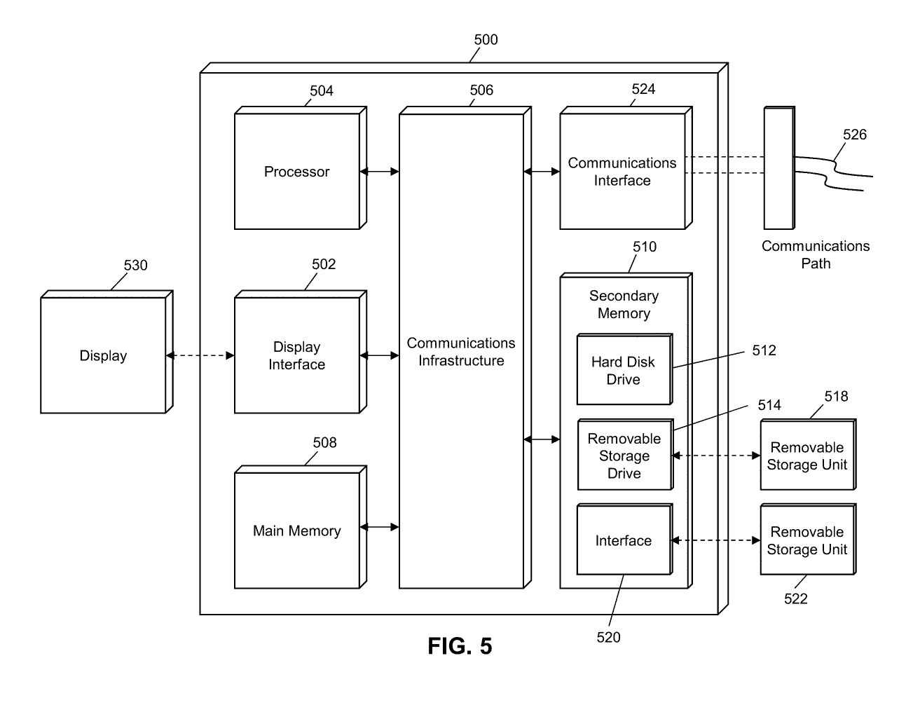

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 500 illustrated in FIG. 5 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from computing devices 106, issuing institutions 108, payment networks 110, and other systems and entities via one or more communication methods, such as local area networks, wireless area networks, cellular communication networks, payment rails, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by computing devices 106, which may be superimposed or otherwise encoded with currency exchange requests, requesting an arbitrary exchange of currency from one currency at a specific rate or for a second amount of another currency, payment details, or exchange confirmations, confirming a currency exchange requested via another computing device 106. The receiving device 202 may also be configured to receive data signals electronically transmitted by issuing institutions 108, such as may be superimposed or otherwise encoded with CPNs or data associated therewith, such as transaction account details associated with a transaction account on which the processing server 102 may issue CPNs. The receiving device 202 may also be configured to receive data signals electronically transmitted by payment networks 110, which may be superimposed or otherwise encoded with responses for payment transactions submitted thereto, such as may indicate if payment transactions for payment from individuals 104 to issuing institutions 108 are approved or denied.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 216, data identification module 218, generation module 220, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include an account database 206. The account database 206 may be configured to store a plurality of account profiles 208 using a suitable data storage format and schema. The account database 206 may be a relational database that utilizes structured query language for the storage, identification, modifying, updating, accessing, etc. of structured data sets stored therein. Each account profile 208 may be a structured data set configured to store data related to a transaction account. Each account profile 208 may include at least account details for the transaction account and a currency type associated therewith. In some cases, the account details may include payment details for use in mapping a CPN to the related transaction account. In other cases, the account details may include details for communicating with the issuing institution 108 associated with the related transaction account, such as for requesting a CPN for the related transaction account. The currency type may be the type of currency that the related transaction account deals in, which may be the currency that the related transaction account must use to pay or receive funds in electronic payment transactions.

The processing server 102 may include a querying module 216. The querying module 216 may be configured to execute queries on databases to identify information. The querying module 216 may receive one or more data values or query strings, and may execute a query string based thereon on an indicated database, such as the account database 206, to identify information stored therein. The querying module 214 may then output the identified information to an appropriate engine or module of the processing server 102 as necessary. The querying module 214 may, for example, execute a query on the account database 206 to identify a first account profile 208 that includes a currency type associated with the first currency included in a request (e.g., USD in the above example) and to identify a second account profile 208 that includes a currency type associated with the second currency included in a request (e.g., GBP in the above example).

The processing server 102 may also include a data identification module 218. The data identification module 218 may be configured to identify data for the processing server 102 for the performing of the functions discussed herein. The data identification module 218 may receive an instruction as input, may identify data as instructed, and may output the identified data to another module or engine of the processing server 102. For example, the data identification module 218 may be configured to identify a CPN for a transaction account related to an account profile 208 identified by the querying module 216. In one instance, a CPN may be identified from internal storage of the processing server 102 (e.g., a memory 224 or the account profile 208, such as may include a plurality of CPNs mapped to the related transaction account). In another instance, identification of a CPN may include the submission of a request to an appropriate entity (e.g., the associated issuing institution 108) by the data identification module 218 and receipt of a CPN via the receiving device 202 therefrom. In some cases, the data identification module 218 may be configured to identify transaction controls for a CPN, such as based on data included in a request received via the receiving device 202.

In some embodiments, the processing server 102 may also include a generation module 220. The generation module 220 may be configured to generate data for use in performing the functions of the processing server 102 as discussed herein. The generation module 220 may receive an instruction as input, may generate data based on the instruction, and may output the generated data to another module or engine of the processing server 102. For example, the generation module 220 may be configured to generate a controlled payment number associated with a transaction account related to an account profile 208. The generation module 220 may also be configured to generate transaction messages for submission to a payment network 110 for the processing of electronic payment transactions for payment from individuals 104 to issuing institutions 108 as part of the arbitrary currency exchange discussed herein. The generation module 220 may also be configured to generate other data messages for use in performing the functions discussed herein, such as messages requesting confirmation of currency exchange requests, messages requesting acceptance of modified currency exchange terms, messages conveying CPNs or details associated therewith, messages confirming exchange details, etc.

The processing server 102 may also include a transmitting device 222. The transmitting device 222 may be configured to transmit data over one or more networks via one or more network protocols. In some instances, the transmitting device 222 may be configured to transmit data to computing devices 106, issuing institutions 108, payment networks 110, and other entities via one or more communication methods, such as local area networks, wireless area networks, cellular communication networks, payment rails, the Internet, etc. In some embodiments, the transmitting device 222 may be comprised of multiple devices, such as different transmitting devices for transmitting data over different networks, such as a first transmitting device for transmitting data over a local area network and a second transmitting device for transmitting data via the Internet. The transmitting device 222 may electronically transmit data signals that have data superimposed that may be parsed by a receiving computing device. In some instances, the transmitting device 222 may include one or more modules for superimposing, encoding, or otherwise formatting data into data signals suitable for transmission.

The transmitting device 222 may be configured to electronically transmit data signals to computing devices 106, which may be superimposed or otherwise encoded with currency exchange confirmations, requests for confirmation of currency exchange details, CPNs, etc. The transmitting device 222 may also be configured to electronically transmit data signals to issuing institutions 108, which may be superimposed or otherwise encoded with transaction data, requests for CPNs, transaction controls for application to a CPN, requests for account details, etc. The transmitting device 222 may also be configured to electronically transmit data signals to payment networks 110, which may be superimposed or otherwise encoded with transaction messages or other data messages including transaction data for use in the processing of electronic payment transactions for payments from individuals 104 to issuing institutions 108 as part of the arbitrary exchange of currency.

The processing server 102 may also include a memory 224. The memory 224 may be configured to store data for use by the processing server 102 in performing the functions discussed herein, such as public and private keys, symmetric keys, etc. The memory 224 may be configured to store data using suitable data formatting methods and schema and may be any suitable type of memory, such as read-only memory, random access memory, etc. The memory 224 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 224 may be comprised of or may otherwise include a relational database that utilizes structured query language for the storage, identification, modifying, updating, accessing, etc. of structured data sets stored therein.

### Process for Arbitrary Exchange of Currency via Controlled Payment Numbers

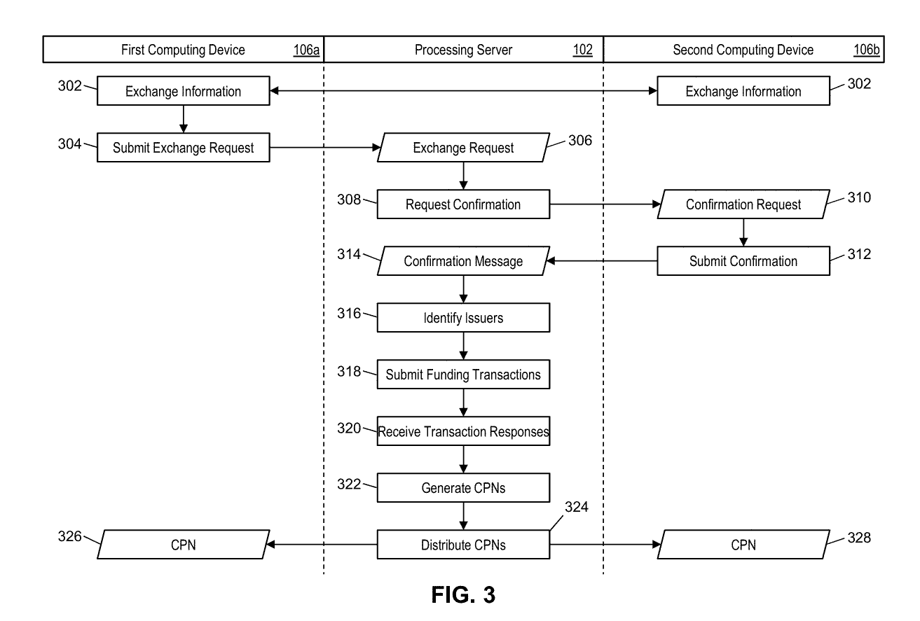

FIG. 3 illustrates a process for the arbitrary exchange of currency from the first individual 104a to the second individual 104b in the system 100 via the processing server 102 and the use of controlled payment numbers (CPN).

In step 302, the first computing device 106a and the second computing device 106b may (e.g., via their associated individuals 104a and 104b) exchange information to agree upon an arbitrary exchange of currency between an amount of a first currency with an amount of a second currency. For instance, in the above example, the first individual 104a and second individual 104b may agree to exchange $100 from the first individual 104b with £85 from the second individual 104b. In some embodiments, the exchange of information may be facilitated by the processing server 102, which may provide a platform to connect each individual 104 to one another based on their desired currencies and requested exchange rates.

In step 304, the first computing device 104a may submit an exchange request to the processing server 102 using a suitable communication network and method. For instance, the exchange request may be submitted via an application program associated with the processing server 102, through a website associated therewith, or via an application programming interface operated by or on behalf of the processing server 102. In step 306, the receiving device 202 of the processing server 102 may receive the exchange request. The exchange request may include at least the first currency and amount, the second currency and amount, communication details associated with the second computing device 106b with whom the currency exchange is being performed, and payment details for payment of the amount of the first currency from the first individual 104a.

In step 308, the transmitting device 222 of the processing server 102 may electronically transmit a confirmation request to the second computing device 106b based on the communication details included in the exchange request. The confirmation request may be received by the second computing device 106b, in step 310, and presented to the second individual 104b as a user thereof. The confirmation request may include at least the details included in the exchange request, such as the first currency and amount and the second currency and amount. In step 312, the second computing device 106b may submit a confirmation message to the processing server 102 for confirmation of the arbitrary currency exchange. In step 314, the receiving device 202 of the processing server 102 may receive the confirmation message, which may include an indication that the terms of the currency exchange are requested, and may also include payment details supplied by the second individual 104b for payment of the amount of the second currency from the second individual 104b.

In step 316, the querying module 216 of the processing server 102 may execute a first query on the account database 206 to identify a first account profile 208 that includes the first currency type, and a second query on the account database 206 to identify a second account profile 208 that includes the second currency type, which may be used by the processing server 102 to identify the first issuing institution 108a and the second issuing institution 108b for participation in the arbitrary currency exchange. In step 318, the transmitting device 222 may electronically transmit transaction details for funding transactions for the arbitrary currency exchange, which may be transmitted to an acquiring institution or other entity associated with the processing server 102 for submission of transaction messages to a payment network 110 for processing. The transaction details may include at least the payment details submitted by the respective individual 104 and the amount of the currency being exchanged by the individual 104 for payment of that amount to the issuing institution 108 associated with the account profile 208 identified for that currency.

In step 320, the receiving device 202 of the processing server 102 may receive response messages for both funding transactions, where the response message for each may indicate that the transactions were approved and successfully processed, thus indicating payments from the individuals 104 to the corresponding issuing institutions 108. In step 322, the generation module 220 of the processing server 102 may generate a CPN for the transaction accounts related to the identified account profiles 208. Each CPN may be mapped to the respective related transaction account and may be limited to the amount of the corresponding currency as indicated in the exchange request. For instance, in the above example, a CPN may be issued on a USD transaction account that is limited to $100, and a CPN may be issued on a GBP transaction account that is limited to £85.

In step 324, the transmitting device 222 of the processing server 102 may electronically transmit data signals superimposed or otherwise encoded with the CPNs to the respective computing devices 106. In step 326, the first computing device 106a may receive the CPN that is mapped to the second issuing institution's transaction account that is limited to the amount of the second currency (e.g., £85 in the above example). In step 328, the second computing device 106b may receive the CPN that is mapped to the first issuing institution's transaction account that is limited to the amount of the first currency (e.g., $100 in the above example). Each of the respective individuals 104 may then be free to spend the currency up to the limited amount using the CPN, without the need to participate in any cross-border transactions.

### Exemplary Method for Arbitrary Exchange of Currency

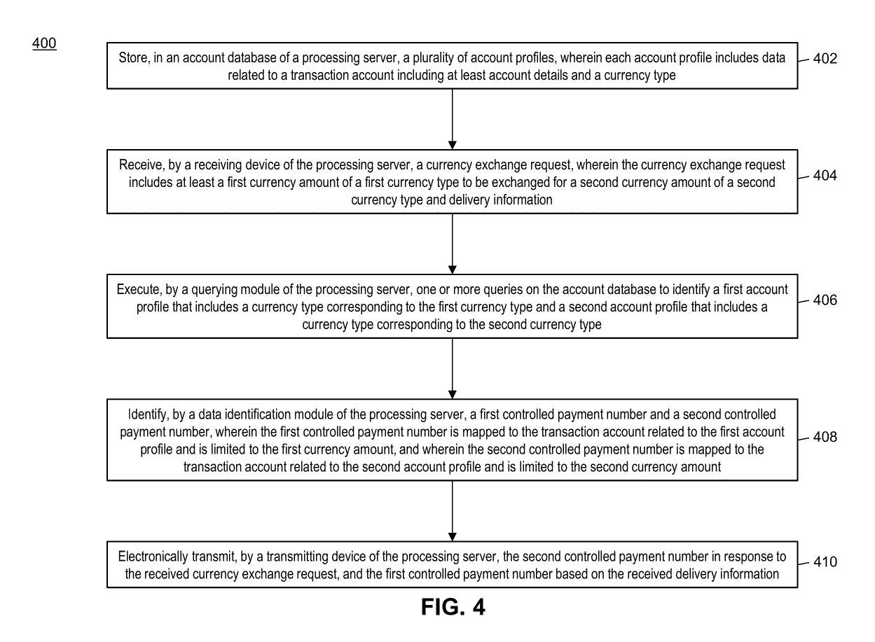

FIG. 4 illustrates a method 400 for the exchange of currency at an arbitrary exchange rate without the use of cross-border transactions, accomplished via the use of controlled payment numbers.

In step 402, a plurality of account profiles (e.g., account profiles 208) may be stored in an account database (e.g., the account database 206) of a processing server (e.g., the processing server 102), wherein each account profile includes data related to a transaction account including at least account details and a currency type. In step 404, a currency exchange request may be received by a receiving device (e.g., the receiving device 202) of the processing server, wherein the currency exchange request includes at least a first currency amount of a first currency type to be exchanged for a second currency amount of a second currency type and delivery information. In step 406, one or more queries may be executed on the account database by a querying module (e.g., the querying module 216) of the processing server to identify a first account profile that includes a currency type corresponding to the first currency type and a second account profile that includes a currency type corresponding to the second currency type.

In step 408, a first controlled payment number and a second controlled payment number may be identified by a data identification module (e.g., the data identification module 218) of the processing server, wherein the first controlled payment number is mapped to the transaction account related to the first account profile and is limited to the first currency amount, and wherein the second controlled payment number is mapped to the transaction account related to the second account profile and is limited to the second currency amount. In step 410, a transmitting device (e.g., the transmitting device 222) of the processing server may electronically transmit the second controlled payment number in response to the received currency exchange request, and the first controlled payment number based on the received delivery information.

In one embodiment, the delivery information may include a communication address associated with a computing device (e.g., the second computing device 106b), and the method 400 may further include: electronically transmitting, by the transmitting device of the processing server, at least the first currency amount, first currency type, second currency amount, and second currency type to the computing device associated with the communication address; and receiving, by the receiving device of the processing server, a confirmation message from the computing device. In a further embodiment, the delivery information may further include a delivery address, the delivery address may be included in the electronic transmission to the computing device, and the first controlled payment number may be electronically transmitted to the delivery address.

In some embodiments, identifying the first controlled payment number and second controlled payment number may include: electronically transmitting, by the transmitting device of the processing server, at least the first currency amount, the second currency amount, the account details included in the first account profile, and the account details included in the second account profile to a third party system; and receiving, by the receiving device of the processing server, the first controlled payment number and the second controlled payment number from the third party system. In one embodiment, the first controlled payment number and the second controlled payment number may have expiration dates based on a date of receipt of the currency exchange request and a predetermined period of time.

In some embodiments, the delivery information may further include a communication address associated with a computing device (e.g., the second computing device 106b), and the second controlled payment number may be electronically transmitted to the computing device associated with the communication address. In one embodiment, the transaction account related to the first account profile and the transaction account related to the second account profile may both associated with a single financial institution. In some embodiments, the currency exchange request may further include payment credentials, and the method 400 may also include electronically transmitting, by the transmitting device of the processing server, at least the payment credentials and first currency amount for initiation of a payment transaction for payment of the currency amount from a transaction account associated with the payment credentials to the transaction account related to the first account profile.

### Computer System Architecture

FIG. 5 illustrates a computer system 500 in which embodiments of the present disclosure, or portions thereof, may be implemented as computer-readable code. For example, the processing server 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for arbitrary exchange of currency. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for arbitrary exchange of currency, comprising:
storing, in an account database of a processing server, a plurality of account profiles, wherein each account profile includes data related to a transaction account including at least account details and a currency type;
receiving, by a receiving device of the processing server, a currency exchange request, wherein the currency exchange request includes at least a first currency amount of a first currency type to be exchanged for a second currency amount of a second currency type and delivery information;
executing, by a querying module of the processing server, one or more queries on the account database to identify a first account profile that includes a currency type corresponding to the first currency type and a second account profile that includes a currency type corresponding to the second currency type;
identifying, by a data identification module of the processing server, a first controlled payment number and a second controlled payment number, wherein the first controlled payment number is mapped to the transaction account related to the first account profile and is limited to the first currency amount, and wherein the second controlled payment number is mapped to the transaction account related to the second account profile and is limited to the second currency amount; and
electronically transmitting, by a transmitting device of the processing server, the second controlled payment number in response to the received currency exchange request, and the first controlled payment number based on the received delivery information.

2. The method of claim 1, wherein the delivery information includes a communication address associated with a computing device, and the method further comprises:
electronically transmitting, by the transmitting device of the processing server, at least the first currency amount, first currency type, second currency amount, and second currency type to the computing device associated with the communication address; and
receiving, by the receiving device of the processing server, a confirmation message from the computing device.

3. The method of claim 2, wherein
the delivery information further includes a delivery address,
the delivery address is included in the electronic transmission to the computing device, and
the first controlled payment number is electronically transmitted to the delivery address.

4. The method of claim 1, wherein identifying the first controlled payment number and second controlled payment number includes:
electronically transmitting, by the transmitting device of the processing server, at least the first currency amount, the second currency amount, the account details included in the first account profile, and the account details included in the second account profile to a third party system; and
receiving, by the receiving device of the processing server, the first controlled payment number and the second controlled payment number from the third party system.

5. The method of claim 1, wherein the first controlled payment number and the second controlled payment number have expiration dates based on a date of receipt of the currency exchange request and a predetermined period of time.

6. The method of claim 1, wherein
the delivery information further includes a communication address associated with a computing device, and
the second controlled payment number is electronically transmitted to the computing device associated with the communication address.

7. The method of claim 1, wherein the transaction account related to the first account profile and the transaction account related to the second account profile are both associated with a single financial institution.

8. The method of claim 1, wherein the currency exchange request further includes payment credentials, and the method further comprises:
electronically transmitting, by the transmitting device of the processing server, at least the payment credentials and first currency amount for initiation of a payment transaction for payment of the currency amount from a transaction account associated with the payment credentials to the transaction account related to the first account profile.

9. A system for arbitrary exchange of currency, comprising:
an account database of a processing server configured to store a plurality of account profiles, wherein each account profile includes data related to a transaction account including at least account details and a currency type;
a receiving device of the processing server configured to receive a currency exchange request, wherein the currency exchange request includes at least a first currency amount of a first currency type to be exchanged for a second currency amount of a second currency type and delivery information;
a querying module of the processing server configured to execute one or more queries on the account database to identify a first account profile that includes a currency type corresponding to the first currency type and a second account profile that includes a currency type corresponding to the second currency type;
a data identification module of the processing server configured to identify a first controlled payment number and a second controlled payment number, wherein the first controlled payment number is mapped to the transaction account related to the first account profile and is limited to the first currency amount, and wherein the second controlled payment number is mapped to the transaction account related to the second account profile and is limited to the second currency amount; and
a transmitting device of the processing server configured to electronically transmit the second controlled payment number in response to the received currency exchange request, and the first controlled payment number based on the received delivery information.

10. The system of claim 9, wherein
the delivery information includes a communication address associated with a computing device,
the transmitting device of the processing server is further configured to electronically transmit at least the first currency amount, first currency type, second currency amount, and second currency type to the computing device associated with the communication address; and
the receiving device of the processing server is further configured to recieve a confirmation message from the computing device.

11. The system of claim 10, wherein
the delivery information further includes a delivery address,
the delivery address is included in the electronic transmission to the computing device, and
the first controlled payment number is electronically transmitted to the delivery address.

12. The system of claim 9, wherein identifying the first controlled payment number and second controlled payment number includes:
electronically transmitting, by the transmitting device of the processing server, at least the first currency amount, the second currency amount, the account details included in the first account profile, and the account details included in the second account profile to a third party system; and
receiving, by the receiving device of the processing server, the first controlled payment number and the second controlled payment number from the third party system.

13. The system of claim 9, wherein the first controlled payment number and the second controlled payment number have expiration dates based on a date of receipt of the currency exchange request and a predetermined period of time.

14. The system of claim 9, wherein
the delivery information further includes a communication address associated with a computing device, and
the second controlled payment number is electronically transmitted to the computing device associated with the communication address.

15. The system of claim 9, wherein the transaction account related to the first account profile and the transaction account related to the second account profile are both associated with a single financial institution.

16. The system of claim 1, wherein
the currency exchange request further includes payment credentials, and
the transmitting device of the processing server is further configured to electronically transmit at least the payment credentials and first currency amount for initiation of a payment transaction for payment of the currency amount from a transaction account associated with the payment credentials to the transaction account related to the first account profile.
